(19) United States
(12) Patent Application Publication
(10) Pub. No.: US 2024/0045412 A1
(43) Pub. Date: Feb. 8, 2024

(54) ABNORMALITY DETECTION DEVICE, ABNORMALITY DETECTION PROGRAM, AND LEARNING DEVICE

(71) Applicants: CHIYODA CORPORATION, Yokohama-shi (JP); GRIDINC, Tokyo (JP)

(72) Inventors: Yuriya MINETA, Yokohama-shi (JP); Tomoyuki OBATA, Yokohama-shi (JP)

(21) Appl. No.: 18/480,689

(22) Filed: Oct. 4, 2023

Related U.S. Application Data
(63) Continuation of application No. PCT/JP2022/004017, filed on Feb. 2, 2022.

(30) Foreign Application Priority Data
Apr. 5, 2021 (JP) 2021-064345

(51) Int. Cl. G05B 23/02

(52) U.S. Cl. CPC G05B 23/0235; G05B 23/0272

(57) ABSTRACT

An abnormality detection device includes: a process value acquirer that acquires, during operation of a plant including a plurality of devices, a process value of at least one monitoring target device among the plurality of devices; a command value acquirer that acquires a command value of a control operation amount for controlling the monitoring target device; and an abnormality detector that detects an abnormality of the monitoring target device on the basis of a relationship between a fluctuation range of a process value acquired by the process value acquirer and a fluctuation range of a command value acquired by the command value acquirer during a predetermined period.

### CROSS REFERENCE TO RELATED APPLICATIONS

This application is a continuation under 35 U.S.C. § 120 of PCT/JP2022/004017, filed Feb. 2, 2022, which is incorporated herein by reference, and which claimed priority to Japanese Application No. 2021-064345, filed Apr. 5, 2021. The present application likewise claims priority under 35 U.S.C. § 119 to Japanese Application No. 2021-064345, filed Apr. 5, 2021, the entire content of which is also incorporated herein by reference.

### BACKGROUND OF THE INVENTION

### 1. Field of the Invention

The present invention relates to an abnormality detection device that detects an abnormality in a plant, an abnormality detection program, and a learning device.

### 2. Description of the Related Art

A technique for monitoring a state change of a plant has been proposed. For example, Patent Literature 1 discloses a technique in which a process value input from a plant every moment is converted into time-series process data and stored, and a plurality of pieces of process data in a predetermined inspection section is statistically processed to detect a change tendency of the process value.
Patent Literature 1: JP 2002-278621 A

### SUMMARY OF THE INVENTION

However, a plant usually includes a large number of control loops, and an abnormality of some control loops may affect other control loops. In this case, even if a process value (PV), a set point (SP), or a manipulated variable (MV) of each control loop is individually monitored, it is difficult to detect a sign of abnormality.

An object of the present disclosure is to improve a technique for detecting an abnormality in a plant.

### Solution to Problem

In order to solve the above problem, an abnormality detection device according to one aspect of the present disclosure includes: a process value acquirer that acquires, during operation of a plant including a plurality of devices, a process value of at least one monitoring target device among the plurality of devices; a command value acquirer that acquires a command value of a control operation amount for controlling the monitoring target device; and an abnormality detector that detects an abnormality of the monitoring target device on the basis of a relationship between a fluctuation range of a process value acquired by the process value acquirer and a fluctuation range of a command value acquired by the command value acquirer during a predetermined period.

Another aspect of the present disclosure is an abnormality detection program. This program causes a computer to function as: a process value acquirer that acquires, during operation of a plant including a plurality of devices, a process value of at least one monitoring target device among the plurality of devices; a command value acquirer that acquires a command value of a control operation amount for controlling the monitoring target device; and an abnormality detector that detects an abnormality of the monitoring target device on the basis of a relationship between a fluctuation range of a process value acquired by the process value acquirer and a fluctuation range of a command value acquired by the command value acquirer during a predetermined period.

Another aspect of the present disclosure is a learning device. This device includes: a learning data acquirer that acquires, as learning data, a fluctuation range of a process value of at least one monitoring target device among a plurality of devices, a fluctuation range of a command value of a control operation amount for controlling the monitoring target device, and information indicating a state of the monitoring target device, which are acquired when a plant including the plurality of devices is operated for a predetermined period; and a learner that learns a detection criterion for detecting an abnormality of the monitoring target device on the basis of an index related to a relationship between the fluctuation range of the process value and the fluctuation range of the command value on the basis of the learning data.

Optional combinations of the aforementioned constituting elements, and implementations of the disclosure in the form of methods, apparatuses, systems, recording mediums, and computer programs may also be practiced as additional modes of the present invention.

### BRIEF DESCRIPTION OF THE DRAWINGS

FIG. 1 is a diagram illustrating an overall configuration of an abnormality detection system according to an embodiment.

FIG. 2 is a diagram illustrating an example of a monitoring target device to be monitored by an abnormality detection device according to the embodiment.

FIG. 3 is a diagram illustrating an example of temporal changes of a process value (PV) and a command value (OP).

FIG. 4 is a diagram illustrating an example of a scatter diagram in which values of PV and OP in a predetermined period are plotted.

FIG. 5 is a diagram illustrating an example of temporal changes of the PV, the OP, and indices.

FIG. 6 is a diagram illustrating an example of temporal changes of the PV, the OP, and index values of the monitoring target device illustrated in FIG. 2.

FIG. 7 is a diagram illustrating an example of temporal changes of the PV, the OP, and the index values of the monitoring target device illustrated in FIG. 2.

FIG. 8 is a diagram illustrating an example of temporal changes of the PV, the OP, and the index values of the monitoring target device illustrated in FIG. 2.

FIG. 9 is a diagram illustrating another example of the monitoring target device to be monitored by the abnormality detection device according to the embodiment.

FIG. 10 is a diagram illustrating an example of temporal changes of the PV, the OP, and the index values of the monitoring target device illustrated in FIG. 9.

FIG. 11 is a diagram illustrating an example of temporal changes of the PV, the OP, and the index values of the monitoring target device illustrated in FIG. 9.

FIG. 12 is a diagram illustrating an example of temporal changes of the PV, the OP, and the index values of the monitoring target device illustrated in FIG. 9.

FIG. 13 is a diagram illustrating an example of temporal changes of the PV, the OP, and the index values when control becomes unstable due to another control loop, disturbance, and the like.

FIG. 14 is a diagram illustrating an example in which indices calculated when a plant is operated are clustered.

FIG. 15 is a diagram illustrating an example of temporal changes in a probability that a monitoring target device transitions from a normal state to an abnormal state.

FIG. 16 is a diagram illustrating an example of temporal changes of indices in a process including a plurality of control loops.

FIG. 17 is a diagram illustrating a configuration of a learning device according to the embodiment.

FIG. 18 is a diagram illustrating a configuration of the abnormality detection device according to the embodiment.

FIGS. 19A, FIGS. 19B, and 19C are diagrams each illustrating an example of temporal changes of indices calculated by an abnormality detection device 10.

### DETAILED DESCRIPTION OF THE INVENTION

The invention will now be described by reference to the preferred embodiments. This does not intend to limit the scope of the present invention, but to exemplify the invention.

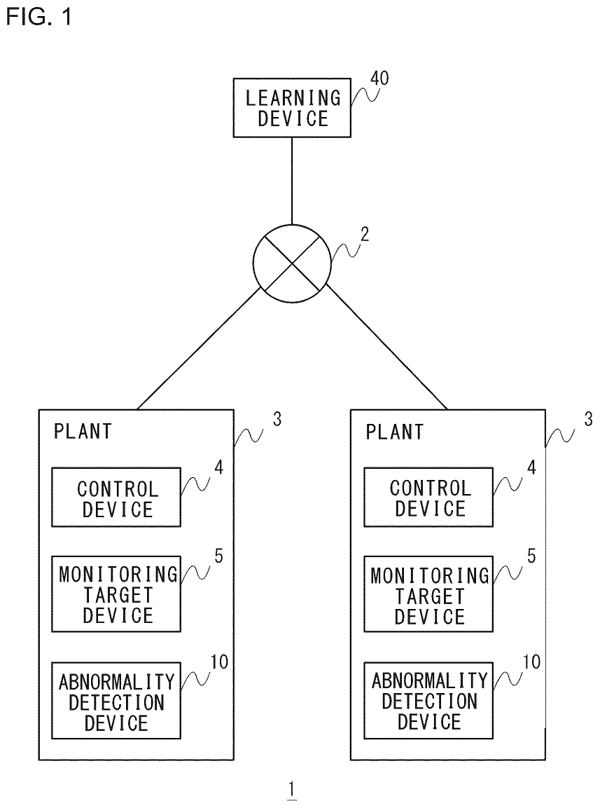

FIG. 1 illustrates an overall configuration of an abnormality detection system according to an embodiment. An abnormality detection system 1 includes a plant 3 that executes a process including a plurality of devices, a monitoring target device 5 to be monitored among the plurality of devices provided in the plant 3, a control device 4 that controls the monitoring target device 5, an abnormality detection device 10 that detects an abnormality of the monitoring target device 5, and a learning device 40 that learns a detection criterion used to detect an abnormality in the abnormality detection device 10. These devices are connected by Internet 2 which is an example of a communication means. The communication means may be any communication means other than the Internet 2.

In a process including a plurality of devices that are automatically feedback controlled independently by a plurality of control devices 4, in a case where the influences of the automatic feedback control can interfere with each other, the influence of an abnormality occurring in a certain device may be propagated to other devices, and the behavior of the entire process may become unstable. The abnormality detection system 1 according to the present embodiment monitors the monitoring target device 5 by the abnormality detection device 10 and detects a sign of an abnormality in the monitoring target device 5, so that it is possible to appropriately deal with the influence of the abnormality before the influence of the abnormality expands to other devices. All of the plurality of devices may be set as the monitoring target device 5, or some of the devices may be set as the monitoring target device 5. In the latter case, among the plurality of devices, a specific important device that may cause serious damage or danger when an abnormality occurs may be set as the monitoring target device 5. In addition, a device that can trigger an abnormality of the important device may be set as the monitoring target device 5. The device that can trigger the abnormality of the important device may be extracted by a fault tree analysis (FTA) in which the abnormality of the important device is set as a high-order event.

The learning device 40 acquires operation record data acquired from the plant 3 when the plant 3 is operated for a predetermined period and learns the detection criterion using the operation record data. The learning device 40 may learn the detection criterion using the operation record data acquired from the plurality of plants 3 including the same type of monitoring target devices 5. As a result, the learning efficiency can be improved, so that the accuracy of the detection criterion can be further improved.

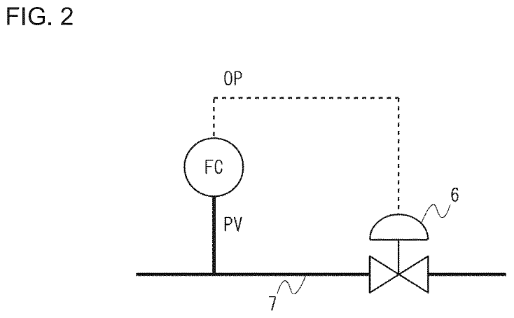

FIG. 2 illustrates an example of the monitoring target device 5 to be monitored by the abnormality detection device 10 according to the embodiment. A valve 6, which is an example of the monitoring target device 5, is opened and closed to control the flow rate of a fluid flowing through a pipe 7. The opening degree of the valve 6 is controlled by a flow controller FC which is an example of the control device 4. The flow controller FC acquires the flow rate of the fluid flowing through the pipe 7 as a process value (PV), calculates a command value (OP) of the opening degree of the valve 6 by PID control or the like so that the flow rate becomes a set point (SP), and transmits the command value (OP) to the valve 6.

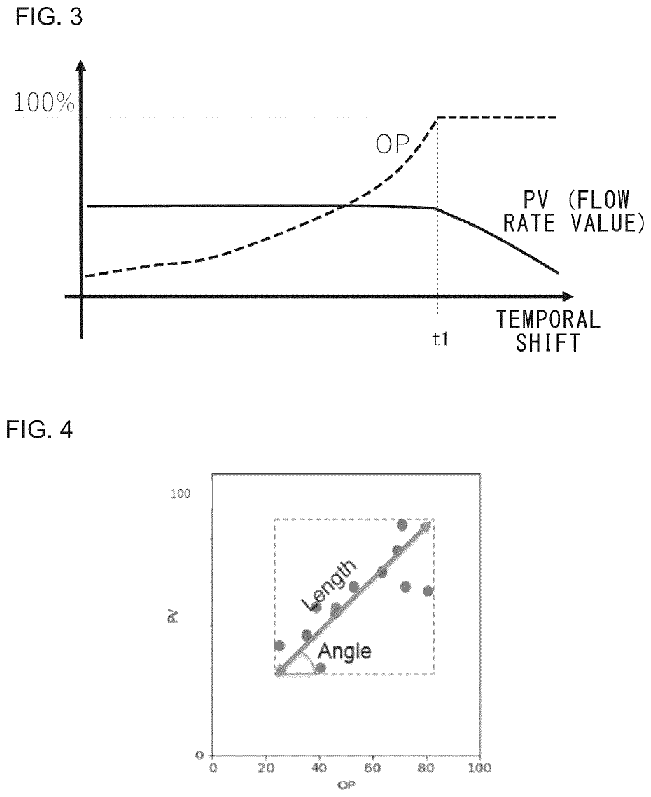

FIG. 3 illustrates an example of temporal changes of the process value (PV) and the command value (OP). In FIG. 3, a solid line indicates the PV, and a broken line indicates the OP. In a period until t1, the PV is maintained substantially constant because the flow controller FC continues to change the OP by feedback control. When the opening degree of the valve 6 reaches 100% at t1, since the opening degree of the valve 6 cannot be changed any more, the PV starts to take an abnormal value. In this example, the abnormality of the PV is detected after t1, but a sign of the abnormality can be seen before t1 in consideration of not only the fluctuation of the PV but also the fluctuation of the OP. That is, even before t1, there is a situation in which the PV cannot be maintained constant unless the opening degree of the valve 6 is continuously changed, and it is considered that some abnormality has occurred before the PV actually takes the abnormal value. However, when only the PV is monitored as in the related art, the abnormality cannot be detected until after t1.

The abnormality detection system 1 of the present embodiment monitors not only the PV but also the OP to detect a sign of abnormality before the PV takes the abnormal value. For example, as in the example illustrated in FIG. 3, in a case where the OP greatly fluctuates when the PV is to be kept constant, there is a possibility that it is a sign of abnormality. In addition, a case where the PV greatly fluctuates even though the OP is substantially constant may be a sign of abnormality. On the other hand, when the PV is to be changed in normal control, the PV and the OP may fluctuate simultaneously. Therefore, in the abnormality detection system 1 of the present embodiment, the abnormality is detected on the basis of the relationship between a fluctuation range of the PV and a fluctuation range of the OP.

FIG. 4 illustrates an example of a scatter diagram in which values of the PV and the OP in a predetermined period are plotted. In FIG. 4, the OP is normalized such that a range is 0 to 100, and the PV is normalized and plotted with the minimum value of a set range of a distributed control system (DCS) as 0 and the maximum value as 100. In the abnormality detection system 1 of the present embodiment, a length L of a diagonal line of the smallest rectangle (plot region) covering each point plotted on the scatter diagram and an angle θ between the diagonal line and a horizontal axis are used as indices for detecting an abnormality. The indices correspond to the magnitude and inclination of a vector having the fluctuation range of the PV and the fluctuation range of the OP in the predetermined period as components. The indices used by the abnormality detection device 10 to detect an abnormality may be one or both of the length L of the diagonal line and the angle θ, or may be a value calculated on the basis of one or both of the length L of the diagonal line and the angle θ. In addition, the indices may be an area, a shape, and the like of the plot region, or may be a statistical value calculated from the values of the PV and the OP by a statistical method.

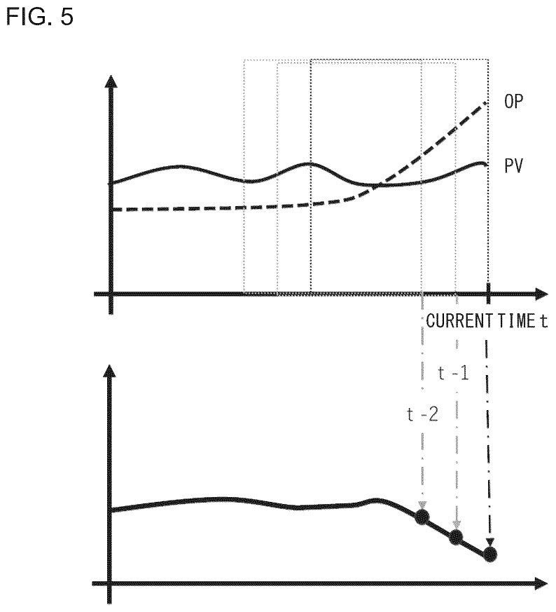

FIG. 5 illustrates an example of temporal changes of the PV, the OP, and indices. The indices at time t are calculated from the fluctuation ranges of the PV and the OP in a predetermined period immediately before time t. Similarly, the indices at time t−1 are calculated from the fluctuation ranges of the PV and the OP in a predetermined period immediately before time t−1. In this manner, by periodically calculating the indices at predetermined timing, for example, at predetermined time intervals and monitoring the value, it is possible to quickly detect an abnormality.

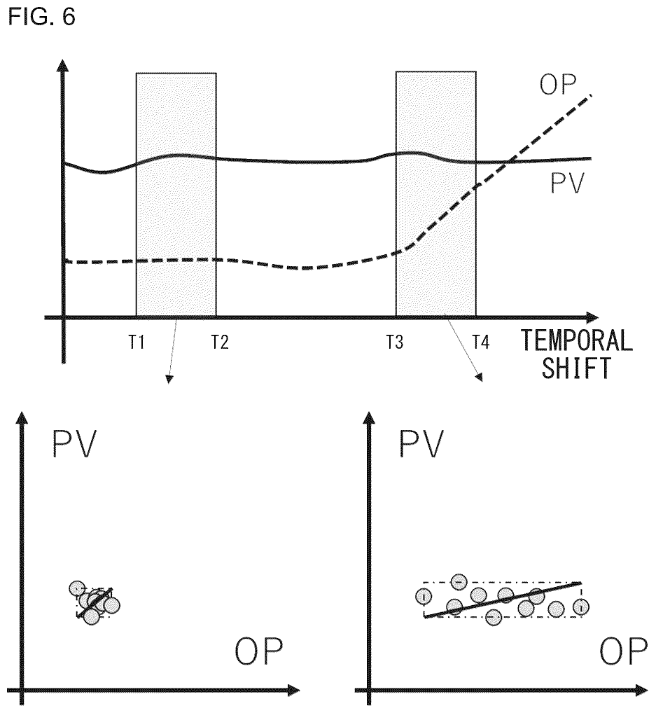

FIG. 6 illustrates an example of temporal changes of the PV, the OP, and the index values of the monitoring target device 5 illustrated in FIG. 2. In the periods T1 to T2, the process state is stable, and the fluctuation range of the PV and the fluctuation range of the OP are small. Therefore, since the plot region has a shape close to a small square, the length L of the diagonal line is short and the angle θ is close to 45°. In the periods T3 to T4, for example, it is assumed that blockage has occurred downstream, and the flow rate is lower than normal. When such an abnormality occurs, since it is necessary to increase the opening degree of the valve 6 in order to maintain the flow rate constant, the fluctuation range of the PV still remains small, but the fluctuation range of the OP becomes large. Therefore, since the plot region is a horizontally long rectangle, the length L of the diagonal line is long and the angle θ is close to 0°.

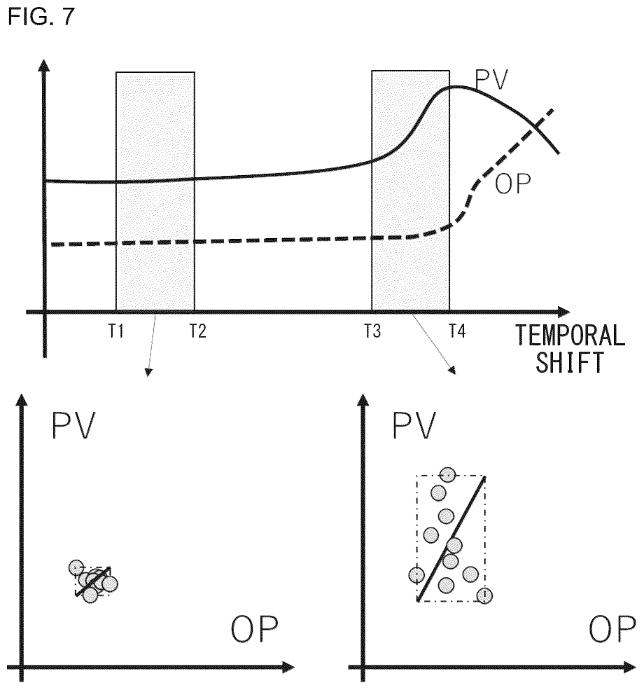

FIG. 7 illustrates an example of temporal changes of the PV, the OP, and the index values of the monitoring target device 5 illustrated in FIG. 2. The periods T1 to T2 are similar to those in the case of FIG. 6. In the periods T3 to T4, for example, it is assumed that the flow rate increases due to a rapid change in an upstream pressure. When such an abnormality occurs, the control of the flow controller FC cannot catch up and only the PV fluctuates, so that the fluctuation range of the OP is small, but the fluctuation range of the PV is large. Therefore, since the plot region is a vertically long rectangle, the length L of the diagonal line is long and the angle θ is close to 90°.

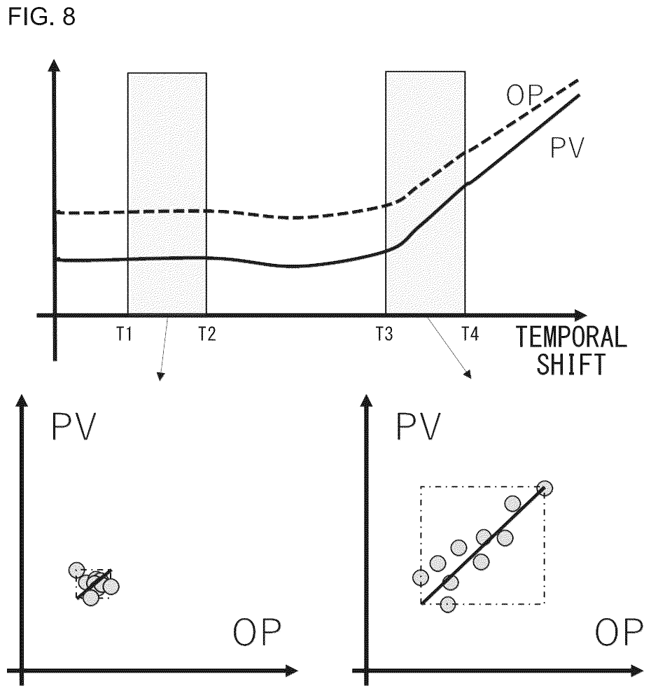

FIG. 8 illustrates an example of temporal changes of the PV, the OP, and the index values of the monitoring target device 5 illustrated in FIG. 2. The periods T1 to T2 are similar to those in the case of FIG. 6. For example, it is assumed that the set point is changed in the periods T3 to T4. At this time, as normal control, the OP rises to raise the flow rate to the set point, and the PV also rises following the rise, so that both the fluctuation range of the PV and the fluctuation range of the OP increase. Therefore, since the plot region has a shape close to a large square, the length L of the diagonal line is long and the angle θ is close to 45°.

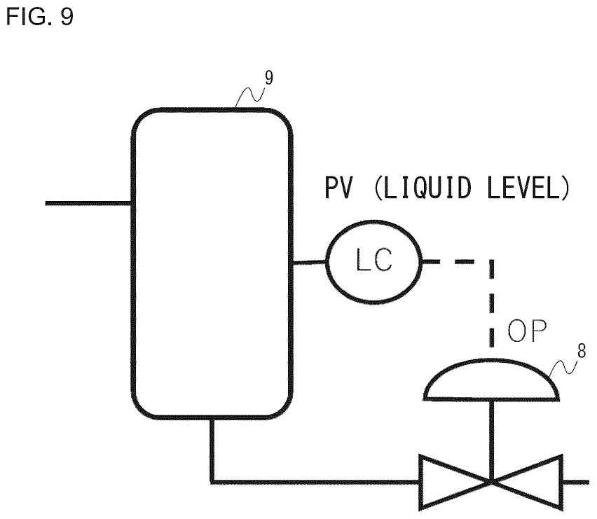

FIG. 9 illustrates another example of the monitoring target device 5 to be monitored by the abnormality detection device 10 according to the embodiment. A valve 8, which is an example of the monitoring target device 5, is opened and closed to control a liquid level of the liquid in a container 9. The opening degree of the valve 8 is controlled by a liquid level controller LC which is an example of the control device 4. The liquid level controller LC acquires the liquid level of the liquid in the container 9 as the process value (PV), calculates the command value (OP) of the opening degree of the valve 6 by PID control or the like so that the flow rate becomes the set point (SP), and transmits the command value (OP) to the valve 6.

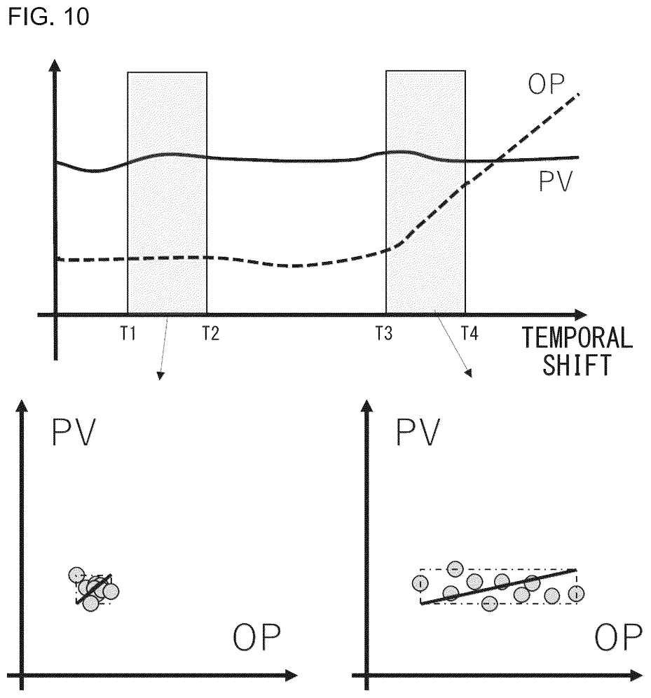

FIG. 10 illustrates an example of temporal changes of the PV, the OP, and the index values of the monitoring target device 5 illustrated in FIG. 9. In the periods T1 to T2, the process state is stable, and the fluctuation range of the PV and the fluctuation range of the OP are small. Therefore, since the plot region has a shape close to a small square, the length L of the diagonal line is short and the angle θ is close to 45°. In the periods T3 to T4, for example, it is assumed that blockage has occurred downstream and the amount of liquid flowing out of the container 9 is smaller than normal. When such an abnormality occurs, since it is necessary to increase the opening degree of the valve 8 in order to maintain the liquid level constant, the fluctuation range of the PV still remains small, but the fluctuation range of the OP becomes large. Therefore, since the plot region is a horizontally long rectangle, the length L of the diagonal line is long and the angle θ is close to 0°.

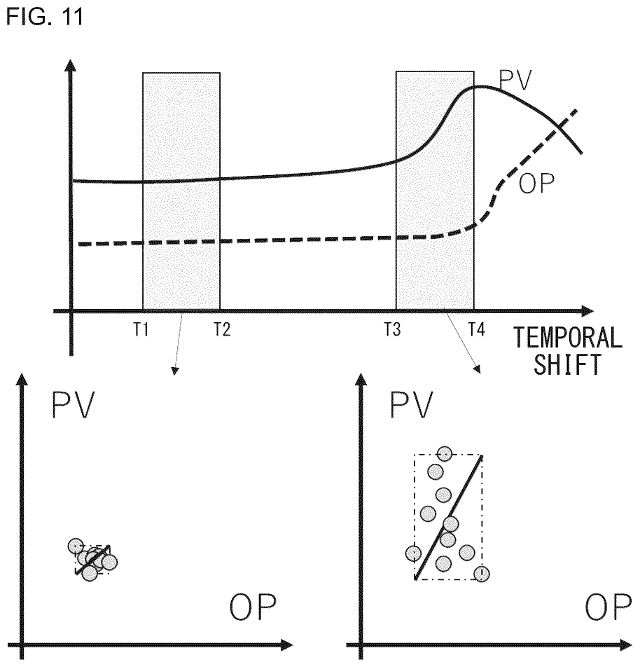

FIG. 11 illustrates an example of temporal changes of the PV, the OP, and the index values of the monitoring target device 5 illustrated in FIG. 9. The periods T1 to T2 are similar to those in the case of FIG. 10. In the periods T3 to T4, for example, it is assumed that the liquid level rises due to a rapid rise in an inflow amount from the upstream. When such an abnormality occurs, the control of the liquid level controller LC cannot catch up and only the PV fluctuates, so that the fluctuation range of the OP is small, but the fluctuation range of the PV is large. Therefore, since the plot region is a vertically long rectangle, the length L of the diagonal line is long and the angle θ is close to 90°.

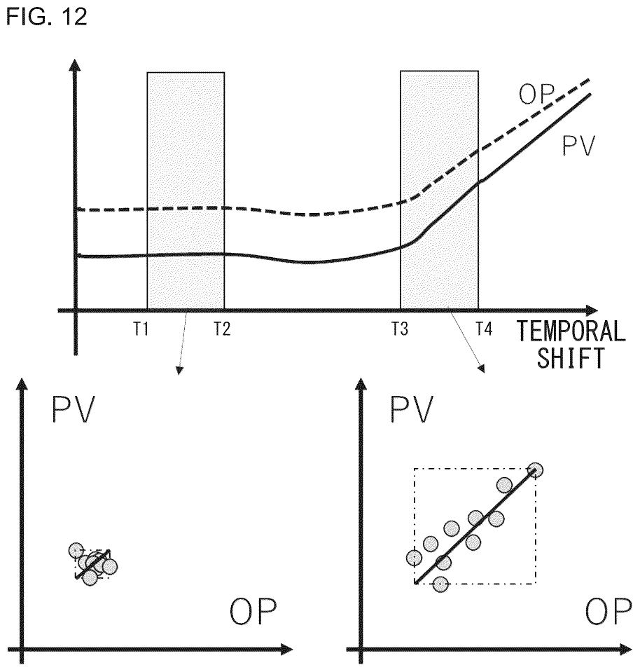

FIG. 12 illustrates an example of temporal changes of the PV, the OP, and the index values of the monitoring target device 5 illustrated in FIG. 9. The periods T1 to T2 are similar to those in the case of FIG. 10. For example, it is assumed that the set point is changed in the periods T3 to T4. At this time, as normal control, the OP rises to raise the liquid level to the set point, and the PV also rises following the rise, so that both the fluctuation range of the PV and the fluctuation range of the OP increase. Therefore, since the plot region has a shape close to a large square, the length L of the diagonal line is long and the angle θ is close to 45°.

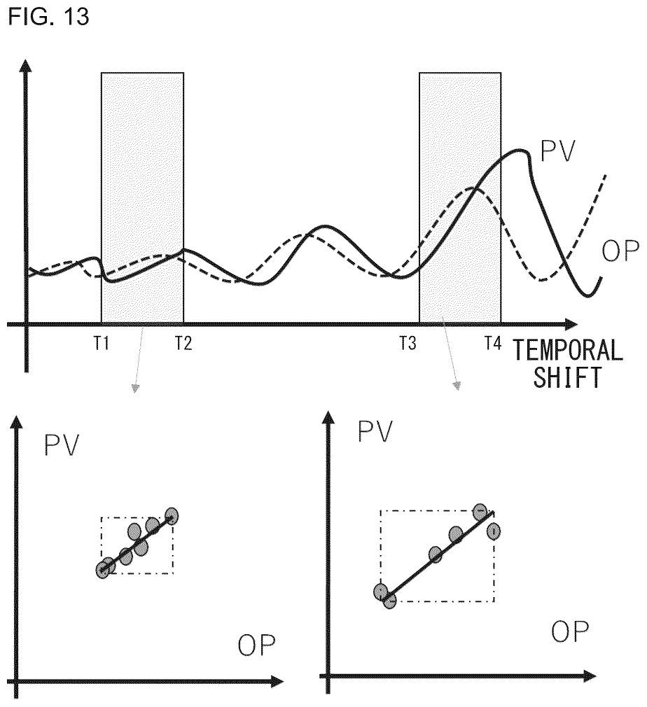

FIG. 13 illustrates an example of temporal changes of the PV, the OP, and the index values when control becomes unstable due to another control loop, disturbance, and the like. In the periods T1 to T2, the process state is stable, and the fluctuation range of the PV and the fluctuation range of the OP are small. Therefore, since the plot region has a shape close to a small square, the length L of the diagonal line is short and the angle θ is close to 45°. In the periods T3 to T4, the control cannot catch up with the influence of other control loops, disturbance, and the like, and the fluctuation range of the PV and the fluctuation range of the OP are large. Therefore, since the plot region has a shape close to a large square, the length L of the diagonal line is long and the angle θ is close to 45°.

As described above, since the length L and the angle θ of the diagonal line of the plot region are correlated with the sign of abnormality of the monitoring target device 5, the length L and the angle θ can be used as indices for detecting abnormality in individual control loops. For example, the abnormality detection device 10 may detect the abnormality of the monitoring target device 5 when the relationship between the normalized PV fluctuation range and the normalized OP fluctuation range is out of the normal range. The relationship between the fluctuation range of the PV and the fluctuation range of the OP may be, for example, a ratio between the fluctuation range of the PV and the fluctuation range of the OP. The abnormality detection device 10 may determine the abnormality on the basis of the tendency that the shape of the vector having the fluctuation range of the PV and the fluctuation range of the OP as components becomes horizontally long or vertically long from the shape during the stable operation or becomes large with the same shape.

The abnormality detection device 10 may detect the abnormality of the monitoring target device 5 further on the basis of the set point of a control operation amount in the predetermined period. By further considering the set point, it is possible to determine a case where normal control is performed due to a change in the set point as illustrated in FIG. 8 and FIG. 12, so that the detection accuracy can be improved.

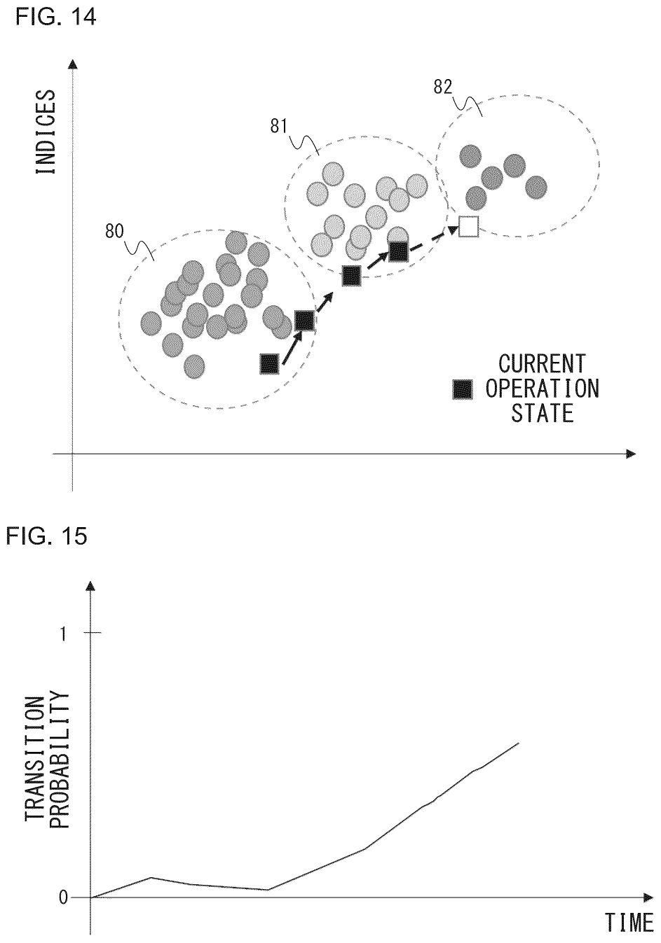

FIG. 14 illustrates an example in which indices calculated when the plant 3 is operated are clustered. The learning device 40 classifies the indices for each state of the monitoring target device 5 by clustering the indices calculated from the PV and the OP when the plant 3 was operated in the past. The learning device 40 may perform clustering using the length L and the angle θ of the diagonal line of the plot region as indices or may perform clustering by reducing the number of dimensions of three or more indices. A region 80 corresponds to clustering of indices in the normal state, a region 81 corresponds to clustering in a state of transition from the normal state to the abnormal state, and a region 82 corresponds to clustering in the abnormal state. The abnormality detection device 10 calculates indices during the operation of the plant 3 and determines clustering to which the calculated indices belong, so that the current state of the monitoring target device 5 can be grasped. The future state of the monitoring target device 5 can be predicted by monitoring the temporal changes of indices.

FIG. 15 illustrates an example of temporal changes in a probability that the monitoring target device 5 transitions from the normal state to the abnormal state. The transition probability may be calculated on the basis of indices calculated from the PV and the OP. The algorithm for calculating the transition probability may be learned by the learning device 40. The transition probability calculation algorithm may be a neural network that inputs indices and outputs a transition probability. The learning device 40 may learn the transition probability calculation algorithm using, as learning data, indices calculated from the PV and the OP when the plant 3 was operated in the past and data representing the state of the monitoring target device 5 at that time. The state of the monitoring target device 5 may be defined by a specific process value range or the like. The abnormality detection device 10 can grasp the current transition probability by calculating indices during the operation of the plant 3 and inputting the calculated indices to the transition probability calculation algorithm. The future state of the monitoring target device 5 can be predicted by monitoring the temporal change of the index.

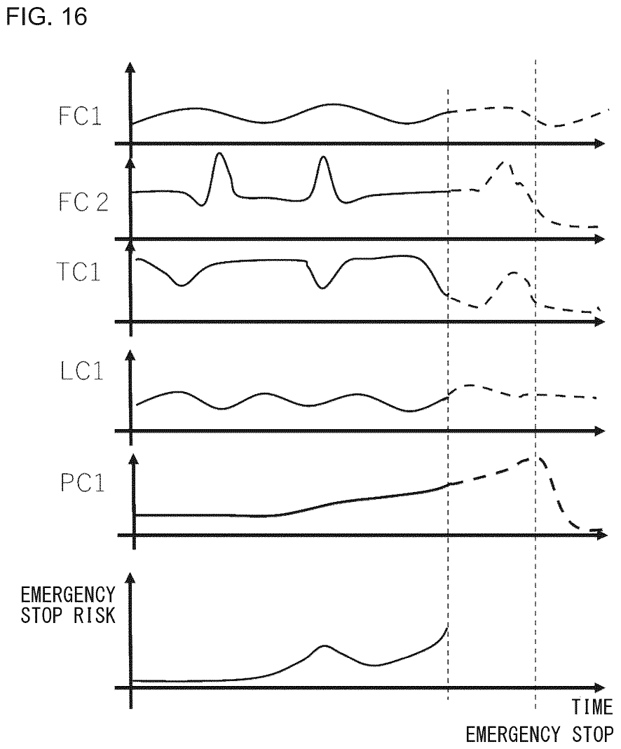

FIG. 16 illustrates an example of temporal changes of indices in a process including a plurality of control loops. The first to fifth stages indicate temporal changes of the indices calculated in the plurality of control loops controlled by the plurality of control devices 4. The sixth stage indicates a temporal change in the risk of emergency stop of the entire process calculated on the basis of these indices. An algorithm for calculating the risk of the emergency stop may be learned by the learning device 40. In the emergency stop risk calculation algorithm, the indices calculated in each control loop may be weighted according to the risk that the abnormality in each control loop causes the emergency stop of the entire process. The emergency stop risk calculation algorithm may be a neural network that inputs indices in each control loop and outputs the emergency stop risk. The learning device 40 may learn the emergency stop risk calculation algorithm using, as learning data, indices calculated from the PV and the OP when the plant 3 was operated in the past, the risk of the emergency stop at that time, the time until the emergency stop, and the like. The abnormality detection device 10 calculates indices in each control loop during the operation of the plant 3 and inputs the calculated indices to the emergency stop risk calculation algorithm, thereby being able to grasp the current emergency stop risk. This makes it possible to predict the future state of the entire process, so that an emergency stop of the process can be avoided by taking appropriate measures as necessary.

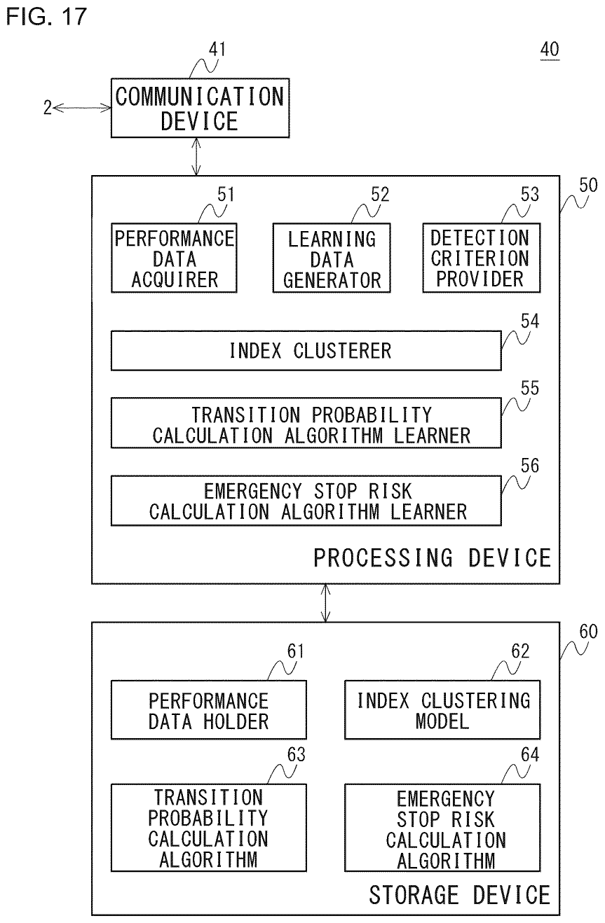

FIG. 17 illustrates a configuration of the learning device 40 according to the embodiment. The learning device 40 includes a communication device 41, a processing device 50, and a storage device 60.

The communication device 41 controls wireless or wired communication. The communication device 41 transmits and receives data to and from other devices via the Internet 2.

The storage device 60 stores data and a computer program used by the processing device 50. The storage device 60 stores a performance data holder 61, an index clustering model 62, a transition probability calculation algorithm 63, and an emergency stop risk calculation algorithm 64. The index clustering model 62, the transition probability calculation algorithm 63, and the emergency stop risk calculation algorithm 64 function as detection criterion used by the abnormality detection device 10 to detect an abnormality in the plant 3.

The performance data holder 61 holds performance data such as the PV and the OP acquired when the plant 3 is operated, the state of the monitoring target device 5, and the state of the process.

The processing device 50 includes a performance data acquirer 51, a learning data generator 52, a detection criterion provider 53, an index clusterer 54, a transition probability calculation algorithm learner 55, and an emergency stop risk calculation algorithm learner 56. In terms of hardware components, these configurations are realized by a CPU, a memory, a program loaded in a memory, and the like of an arbitrary computer, but here, functional blocks realized by cooperation thereof are illustrated. Therefore, it is understood by those skilled in the art that these functional blocks can be realized in various forms by only hardware, only software, or a combination thereof.

The performance data acquirer 51 acquires performance data such as the PV and the OP acquired when the plant 3 is operated, the state of the monitoring target device 5, and the state of the process, and stores the performance data in the performance data holder 61.

The learning data generator 52 generates learning data from the performance data stored in the performance data holder 61. The learning data generator 52 calculates indices from the PV and the OP. The learning data generator 52 calculates a numerical value representing the state of the monitoring target device 5 on the basis of the specific PV or the like.

The index clusterer 54 learns the index clustering model 62 by clustering the indices calculated by the learning data generator 52.

The transition probability calculation algorithm learner 55 learns the transition probability calculation algorithm 63 using the learning data generated by the learning data generator 52. When the indices are input to an input layer, the transition probability calculation algorithm learner 55 may learn the transition probability calculation algorithm 63 by adjusting an intermediate layer of the neural network so that the transition probability at that time is output from an output layer.

The emergency stop risk calculation algorithm learner 56 learns the emergency stop risk calculation algorithm 64 using the learning data generated by the learning data generator 52. When the indices in each control loop are input to the input layer, the emergency stop risk calculation algorithm learner 56 may learn the emergency stop risk calculation algorithm 64 by adjusting the intermediate layer of the neural network so that the risk of the emergency stop at that time is output from the output layer.

The detection criterion provider 53 provides the learned index clustering model 62, the transition probability calculation algorithm 63, and the emergency stop risk calculation algorithm 64 to the abnormality detection device 10.

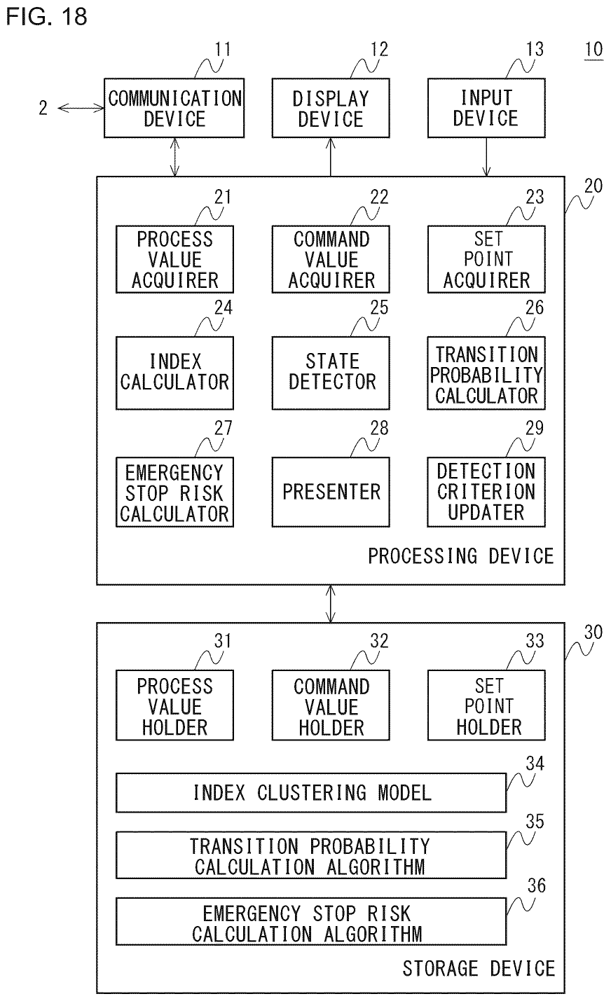

FIG. 18 illustrates a configuration of the abnormality detection device 10 according to the embodiment. The abnormality detection device 10 includes a communication device 11, a display device 12, an input device 13, a processing device 20, and a storage device 30.

The communication device 11 controls wireless or wired communication. The communication device 11 transmits and receives data to and from other devices via the Internet 2. The display device 12 displays the display image generated by the processing device 20. The input device 13 inputs an instruction to the processing device 20.

The storage device 30 stores data and a computer program used by the processing device 20. The storage device 30 stores a process value holder 31, a command value holder 32, a set point holder 33, an index clustering model 34, a transition probability calculation algorithm 35, and an emergency stop risk calculation algorithm 36.

The processing device 20 includes a process value acquirer 21, a command value acquirer 22, a set point acquirer 23, an index calculator 24, a state detector 25, a transition probability calculator 26, an emergency stop risk calculator 27, a presenter 28, and a detection criterion updater 29. These configurations can also be realized in various forms by only hardware, only software, or a combination thereof.

The process value acquirer 21 acquires a process value from the control device 4, the monitoring target device 5, a sensor that detects the process value, and the like, and stores the process value in the process value holder 31. The command value acquirer 22 acquires a command value from the control device 4 and stores the command value in the command value holder 32. The set point acquirer 23 acquires a set point from the control device 4 and stores the set point in the set point holder 33.

The index calculator 24 calculates indices on the basis of the process value of the predetermined period stored in the process value holder 31 and the command value of the predetermined period stored in the command value holder 32.

The state detector 25 detects the state of the monitoring target device 5 by inputting the indices calculated by the index calculator 24 to the index clustering model 34.

The transition probability calculator 26 calculates the transition probability by inputting the indices calculated by the index calculator 24 to the transition probability calculation algorithm 35.

The emergency stop risk calculator 27 calculates the risk of emergency stop by inputting the indices in each control loop calculated by the index calculator 24 to the emergency stop risk calculation algorithm 36.

The presenter 28 displays, on the display device 12, the detection result by the state detector 25, the transition probability calculated by the transition probability calculator 26, and the risk of the emergency stop calculated by the emergency stop risk calculator 27. In addition, the presenter 28 displays, on the display device 12, a temporal change in the shape of the vector having the fluctuation range of the process value and the fluctuation range of the command value as components. This allows the operator to accurately predict the future state of the entire process and to avoid an emergency stop of the process by taking appropriate measures as necessary.

The detection criterion updater 29 acquires the index clustering model 62, the transition probability calculation algorithm 63, or the emergency stop risk calculation algorithm 64 relearned by the learning device 40 from the learning device 40, and updates the index clustering model 34, the transition probability calculation algorithm 35, or the emergency stop risk calculation algorithm 36.

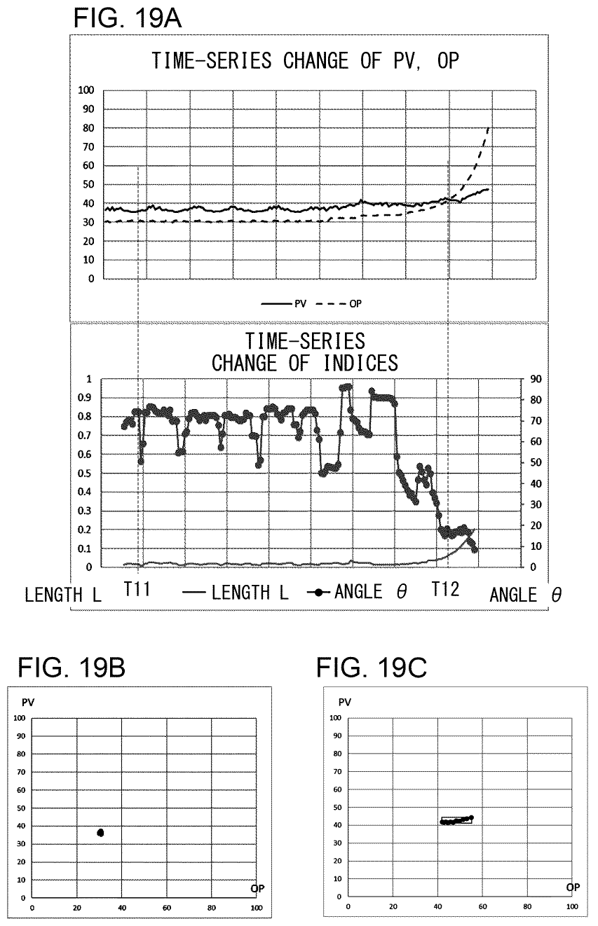

FIGS. 19A, FIG. 19B, and FIG. 19C each illustrate an example of temporal changes of indices calculated by the abnormality detection device 10. FIG. 19A illustrates temporal changes of the PV and the OP and temporal changes of calculated indices (length L of diagonal line and angle θ). FIG. 19B is a scatter diagram of the PV and the OP at a predetermined time before time T11, and FIG. 19C is a scatter diagram of the PV and the OP at a predetermined time before time T12. From immediately before time T12, the OP starts to take an abnormal value, and similarly, the indices also start to take an abnormal value greatly deviating from the normal value. Therefore, it is possible to accurately detect a sign of abnormality in the control loop on the basis of the indices.

The present invention has been described above on the basis of the embodiments. The embodiments are intended to be illustrative only and it will be understood by those skilled in the art that various modifications to their constituting elements and processes can be made and that such modifications are also within the scope of the present invention.

The present invention is applicable to an abnormality detection device that detects an abnormality in a plant.

What is claimed is:

1. An abnormality detection device comprising:
a process value acquirer structured to acquire, during operation of a plant including a plurality of devices, a process value of at least one monitoring target device among the plurality of devices;
a command value acquirer structured to acquire a command value of a control operation amount for controlling the monitoring target device; and
an abnormality detector structured to detect an abnormality of the monitoring target device on a basis of a relationship between a fluctuation range of a process value acquired by the process value acquirer and a fluctuation range of a command value acquired by the command value acquirer during a predetermined period.

2. The abnormality detection device according to claim 1, wherein
the abnormality detector is structured to detect an abnormality of the monitoring target device using a detection criterion for detecting an abnormality of the monitoring target device on a basis of an index related to a relationship between a fluctuation range of the process value and a fluctuation range of the command value.

3. The abnormality detection device according to claim 2, wherein
the index is a magnitude or an inclination of a vector having a fluctuation range of the process value and a fluctuation range of the command value as components.

4. The abnormality detection device according to claim 2, wherein
the detection criterion is machine-learned on a basis of a fluctuation range of the process value, a fluctuation range of the command value, and a state of the monitoring target device in a past predetermined period.

5. The abnormality detection device according to claim 1, wherein
the abnormality detector is structured to detect an abnormality of the monitoring target device when a relationship between a fluctuation range of the process value and a fluctuation range of the command value is out of a normal range.

6. The abnormality detection device according to claim 1, wherein
the abnormality detection device determines an abnormality on a basis of a tendency that a shape of a vector having a fluctuation range of the process value and a fluctuation range of the command value as components becomes horizontally long or vertically long from a shape during a stable operation or becomes large with the same shape.

7. The abnormality detection device according to claim 3, wherein
the abnormality detection device displays a temporal change of the shape of the vector on a display device.

8. The abnormality detection device according to claim 1, wherein
the abnormality detector is structured to detect an abnormality of the monitoring target device further on a basis of a set point of the control operation amount in the predetermined period.

9. An abnormality detection program causing a computer to function as
a process value acquirer structured to acquire, during operation of a plant including a plurality of devices, a process value of at least one monitoring target device among the plurality of devices;
a command value acquirer structured to acquire a command value of a control operation amount for controlling the monitoring target device; and
an abnormality detector structured to detect an abnormality of the monitoring target device on a basis of a relationship between a fluctuation range of a process value acquired by the process value acquirer and a fluctuation range of a command value acquired by the command value acquirer during a predetermined period.

10. A learning device comprising:
a learning data acquirer structured to acquire, as learning data, a fluctuation range of a process value of at least one monitoring target device among a plurality of devices, a fluctuation range of a command value of a control operation amount for controlling the monitoring target device, and information indicating a state of the monitoring target device, which are acquired when a plant including the plurality of devices is operated for a predetermined period; and
a learner structured to learn a detection criterion for detecting an abnormality of the monitoring target device on a basis of indices related to a relationship between the fluctuation range of the process value and the fluctuation range of the command value on a basis of the learning data.

11. The abnormality detection device according to claim 3, wherein
the detection criterion is machine-learned on a basis of a fluctuation range of the process value, a fluctuation range of the command value, and a state of the monitoring target device in a past predetermined period.

12. The abnormality detection device according to claim 2, wherein
the abnormality detector is structured to detect an abnormality of the monitoring target device when a relationship between a fluctuation range of the process value and a fluctuation range of the command value is out of a normal range.

13. The abnormality detection device according to claim 2, wherein
the abnormality detection device determines an abnormality on a basis of a tendency that a shape of a vector having a fluctuation range of the process value and a fluctuation range of the command value as components becomes horizontally long or vertically long from a shape during a stable operation or becomes large with the same shape.

14. The abnormality detection device according to claim 4, wherein
the abnormality detection device displays a temporal change of the shape of the vector on a display device.

15. The abnormality detection device according to claim 5, wherein
the abnormality detection device displays a temporal change of the shape of the vector on a display device.

16. The abnormality detection device according to claim 6, wherein
the abnormality detection device displays a temporal change of the shape of the vector on a display device.

17. The abnormality detection device according to claim 2, wherein
the abnormality detector is structured to detect an abnormality of the monitoring target device further on a basis of a set point of the control operation amount in the predetermined period.

18. The abnormality detection device according to claim 3, wherein
the abnormality detector is structured to detect an abnormality of the monitoring target device further on a basis of a set point of the control operation amount in the predetermined period.

19. The abnormality detection device according to claim 4, wherein
the abnormality detector is structured to detect an abnormality of the monitoring target device further on a basis of a set point of the control operation amount in the predetermined period.

20. The abnormality detection device according to claim 5, wherein
the abnormality detector is structured to detect an abnormality of the monitoring target device further on a basis of a set point of the control operation amount in the predetermined period.
